(19) United States
(12) Patent Application Publication
(10) Pub. No.: US 2012/0111165 A1
(43) Pub. Date: May 10, 2012

(54) FOIL CUTTER AND SOLID CUTTER ROLL

(75) Inventors: Michael Closmann, Raubach (DE); Reinhard Raueiser, Muden (DE)

(73) Assignee: WINKLER + DÜNNEBIER GMBH, Neuwied (DE)

(21) Appl. No.: 13/383,860

(22) PCT Filed: Jul. 16, 2010
(86) PCT No.: PCT/EP2010/060317

§ 371 Date: Jan. 13, 2012

(30) Foreign Application Priority Data
Jul. 16, 2009 (DE) 10 2009 033 576.5

(51) Int. Cl. B26D 7/18; B26D 1/62

(52) U.S. Cl. 83/100

(57) ABSTRACT

A foil cutter for use on the surface area of a carrier roller of a rotary punch has a base plate with a bottom and a top, and at least one blade arranged on the top of the base plate. The top of the base plate has at least one region bordering on the at least one blade and partially or completely surrounded by the at least one blade, in which at least one foil cutter perforation is present through which at least a part of punched flat material can be drawn by suction to be held in the region and be further transported by the carrier roller. The foil cutter has at least one elevation arranged on the top of the base plate in the at least one region bordering on the at least one blade and partially or completely surrounded by the at least one blades.

### BACKGROUND OF THE INVENTION

1. Technical Field

The invention relates to a foil cutter for use on the surface area of a carrier roller of a rotary punch, which roller is provided with a suction- and blowing-air function, whereby the foil cutter comprises a base plate with a bottom and a top, whereby at least one blade is arranged on the top of the base plate and whereby the top of the base plate comprises at least one region bordering on blades and partially or completely surrounded by blades, in which parts of the flat material to be punched can clamp during the punching process in the prior art. Furthermore, the invention relates to a solid cutter roller.

2. Related Art

Rotary punches are known. This punching technology is very widespread in the paper processing industry, tissue processing industry and the foil processing industry, in particular in the production of folding box blanks, banknotes, letter envelopes, mailing pockets, hygienic articles such as, e.g., sanitary napkins and of labels. A rotary punch customarily consists essentially of a cutter roller (roller with a cutting arrangement) that can rotate about its own axis and of a countercutting element constructed as a cutting roller, that is constructed as a countercutting roller with a smooth circumferential roller surface (roller without cutting arrangement) or as a stationary countercutting strip. The punching process brings about a separation of material. Either material parts are separated from each other or a separation takes place between material parts and waste parts. The material parts are to be understood, as, for example, folding box blanks, letter envelope blanks or labels. Waste parts are to be understood as, for example, residual grids, window scraps or residual scraps. In general, in rotary punches, the punched material can become clamped between blades. In order that the punched material can be transferred to subsequent transport units or processing units, very different. devices are used that separate the clamped punching parts again. The use of elastically supported mechanical ejectors such as are described, for example, in DE 73 05 842 U is known. Furthermore, the use of needles in combination with wipers such as described, for example, in DE 199 36 854 C1 is known. The use of blowing air and of a separating blade as ejection means is described in DE 26 07 812 A1. U.S. Pat. No. 5,701,789 and DE 102 48 124 A1 describe the use of foil cutters in rotary punches and of elastic elements as a component of the foil cutter or in combination with the foil cutter that separates the punched material parts or waste parts from the foil cutter in order to make possible the transfer of the punched parts to subsequent transport units or processing units.

Definition of concept: if the concept “punched part” is used in the following, this denotes “material parts” as well as “waste parts”.

The known devices do not prevent the clamping of the punched parts between the blades of the cutter roller but rather require in some instances an expensive and in some instances disturbing separation of the punched parts which does not begin until after the clamping. This is explained in detail following U.S. Pat. No. 5,701,789 and DE 102 48 124 A1. The material to be punched is first pressed in the direction of the cutting bottom, during which it overcomes the spring force of the mechanical ejector and is clamped between the customarily oblique flanks of the blade. The tensioned springs release their energy after the punching process again and separate the clamping. This separation and/or ejection is disturbing if a transfer of the punched parts that is precisely in sync with the machine cycle is to take place subsequently, or if a long (viewed in the material level M) punched part is to be transferred. A fluttering of the punched part occurs in the multiple placing of the ejectors per punched part and the simultaneously high processing speed that may be necessary under certain conditions. In addition, undesired markings on the product can occur with these elastic, mechanical ejectors.

Moreover, in some known devices on carrier rollers with suction- and blowing-air function, the suitable positions of the air perforations in the foil cuter intersect with those of the ejectors. In the case of a window scrap, e.g., the advance cutting edge should be caught with the suction air (otherwise, the advance cutting edge is flipped over at high processing speeds), but even the separating of the scrap from the roller after the punching process must, for the sake of a precise transfer or forwarding of the scrap, begin at the advance cutting edge of the scrap.

Furthermore, the known devices, in the case of cutting contour sections lying very close to each other or in the case of very small, closed contours=window contours (e.g., circular cutting contours with a diameter 6 mm) they either can no longer be used on account of reasons of space and fastening (separate elastic ejectors) or they cannot achieve the desired ejection action.

With carrier rollers with suction- and blowing-air function, the arrangement density of the suction- and blowing-air openings is limited and therefore more adaptation ability with regard to the arrangement of air perforations and output means is required from the foil cutter. In the case of an arrangement of the elastic ejector in the immediate vicinity of the suction opening no reliable suction effect is achieved.

A fastening of the known elastic ejectors is also not conceivable when using a solid cutter roller (see below for an explanation of the concept solid cutter roller) in conjunction with cutting contour sections lying close to each other or with very small, closed contours.

### SUMMARY

One or more embodiments of the present invention provides a foil cutter and/or a solid cutter roller that prevent the clamping of the punched part on the cutting roller and makes possible a reliable transfer of punched parts to following transport units or processing units. One or more embodiments of the present invention allows unlimited use of suction- and blowing air, low blowing-air pressure, use with cutting contour sections located close to each other or with very small, closed cutting contours, transfer of the punched parts that is precisely in sync with the machine cycle, and calm and protective transport of the punched material.

According to one or more embodiments of the invention, the foil cutter comprises at least one elevation arranged on the top of the base plate in the at least one region bordering on blades and partially or completely surrounded by the blades, which elevation is arranged, constructed and connected to the foil cutter in such a manner that it prevents a clamping of the punched flat material or partial areas of the punched flat material. The prevention of the clamping takes place in that the at least one elevation provided in accordance with one or more embodiments of the invention results in a curvature or corrugation or unevenness of the punched flat material drawn in by suction. The elevation in the sense of one or more embodiments of the present invention must therefore always be shaped in such a manner that a curvature of the punched flat material can be produced in the previously cited manner.

One or more embodiments of the present invention has the advantage that the dipping of the punched material during the punching process in the direction of the base plate is counteracted by the elevation and a clamping of the punched parts is prevented in advance. According to one or more embodiments of the present invention, ejecting of the punched part is no longer necessary. When blowing air is used to separate the punched part from the cutter roller, the work can be performed with lower pressures, which contributes to a lowering of the emission of noise and of the consumption of the compressed air.

In one or more embodiments of the present invention, the foil cutter is tightened onto the surface area of the carrier roller.

In one or more embodiments of the present invention, the foil cutter is held by magnetic force on the surface area of the carrier roller.

According to one or more embodiments of the present invention, the foil cutter is held by clamping force on the surface area of the carrier roller.

According to one or more embodiments of the present invention, the foil cutter is held positively on the surface area of the carrier roller.

According to one or more embodiments of the present invention, the foil cutter is held by adhesive force on the surface area of the carrier roller and it is possible that the foil cutter is held by suction air on the surface area of the carrier roller.

Of course, a combination of the previously cited holding principles can also be selected for fixing the foil cutter.

The use of a carrier roller with suction- and blowing air function is possible.

The elevation according to one or more embodiments of the present invention is designed as a web, plateau, pin, blade or as a bead. These design variants can also be combined. The advantage of one or more embodiments of the present invention is the flexibility that is necessary for preventing a clamping of different punched part forms and sizes. Finally, the actual form and the course of the elevations can not be completely defined by the concepts introduced above. These concepts are intended to impart an idea of the possibilities of using one or more embodiments of the invention.

Elevations according to one or more embodiments of the present invention comprise at least one opening for the passage of suction- and/or blowing air. This makes possible the unlimited use of suction- and blowing air. The limited density of the raster of the roller holes and the ability of the foil cutter to adapt that is necessary as a consequence is taken into account by the cooperation of the flexibility in the positioning of the elevations and of the suction- and blowing air function.

In addition, according to one or more embodiments of the present invention, the elevation, viewed from a top view of the foil cutter, has a direct connection with a cutting contour. Thus, the clamping of the punched parts can be counteracted, in particular in the actual clamping zones.

According to one or more embodiments of the present invention, the elevation, viewed from a top view of the foil cutter, has a direct connection with several cutting contour section of one or more blades. Thus, the clamping of the punched parts can be counteracted simultaneously in several clamping zones.

According to one or more embodiments of the present invention, the elevation, viewed from a top view of the foil cutter, is placed between or adjacent to cutting contour sections of one or more blades without being directly connected to them. The punched material is guided better as a result. This contributes to a calm transport of the punched material.

The combination of the embodiments described in the two previous paragraphs is of course also possible.

In one or more embodiments of the present invention, the height h of the elevation is less than the cutting height H or equal to the cutting height H and the difference in height Δ h is in a range of 0% to 70% of the cutting height H.

In one or more embodiments of the present invention, the height h of the elevation is less than the cutting height H and the difference in height Δ h is in a range of 10% to 50% of the cutting height H.

The foil cutter may be used in accordance with one or more embodiments of the invention in conjunction with a countercutting element that is designed as a countercutting roller with a smooth roller surface.

However, the use of the foil cutter in accordance with one or more embodiments of the invention is also suitable in conjunction with a countercutting element that is also designed itself as a cutting roller with a blade arrangement.

Furthermore, the use of the foil cutter in accordance with one or more embodiments of the invention is suitable in conjunction with a countercutting element that is designed as a stationary countercutting element (e.g., countercutting strip or blade).

The use of the foil cutter in accordance with one or more embodiments of the invention is advantageous with closed cutting contours if the surface of the region completely surrounded by blades is less than or equal to 150 mm².

One or more embodiment the invention can also be used with a solid cutter roller in which the elevations are arranged, constructed and connected to the solid cutter roller in such a manner that they prevent a clamping of the punched flat material or of partial areas of the punched flat material. In the case of solid cutter rollers the blades are arranged on the circumferential surface of the roller and connected in one piece to the roller, i.e., they are a component of the cutter roller.

In one or more embodiments of the present invention, the cutting height here is maximally 3 mm.

According to one or more embodiments of the present invention, the cutting height is maximally 2 mm.

Aside from the fact that in a solid cutter roller the elevation in accordance with one or more embodiments of the invention is a component of the cultural roller, possible suction- and blowing air functions are contained directly in the cutter roller and that fastening variants for foil cutters are not considered, the same embodiment variants result as in the use of the above-described foil cutter.

The elevations are ideally designed in a solid construction in the foil cutter as well as in the solid cutter roller. I.e., in the case of the foil cutter the bottom of the elevation (the side facing the carrier roller) forms, with the bottom of the base plate, a continuous surface and there is no hollow space between the bottom of the elevation and the top of the elevation (the side facing the punched material). The air perforations constitute an exception to this. The elevation is supported against the carrier roller. Even in the case of the solid cutter roller there is no hollow space between the elevation or the top of the elevation and between the cutter roller. The air perforations constitute an exception to this.

According to one or more embodiments of the present invention, the elevation is a component of the foil cutter or, if a solid cutter roller is used, a component of the solid cutter roller. I.e., there is a material connection between the elevation and the foil cutter or between the elevation and the solid cutter roller.

Ideally, the elevation and the foil cutter or the elevation and the solid cutter roller are manufactured from one material.

The following may apply to one or embodiments: The height of the actual blade is understood to by the blade height H. FIG. 5 illustrates this. The lower, i.e., the dimension relative to the height h of the elevation, which dimension is closer to the base plate or to the cutter roller, is at the same level (observation of the unwound foil cutter or of the unwound surface of the cutter roller) as the lower dimension relative to the blade height H. This level can coincide with the top of the base plate of the foil cutter or with the circumferential roller surface of the cutter roller or can be parallel to and at a distance from the top of the base plate of the foil cutter or of the circumferential roller surface of the cutter roller.

### BRIEF DESCRIPTION OF THE DRAWINGS

The invention is explained in detail in the following using several exemplary embodiments. In the associated drawings:

FIG. 1 shows a top view section of the foil cutter in accordance with one or more embodiments of the invention in an unwound state and shows an associated sectional view.

FIG. 2 shows a top view section of the of the foil cutter in accordance with one or more embodiments of the invention in an unwound state and shows an associated sectional view.

FIG. 3 shows a top view section of the of the foil cutter in accordance with one or more embodiments of the invention in an unwound state and shows an associated sectional view.

FIG. 4 shows a schematic view of a rotary punch.

FIG. 5 shows a top view section of an unwound circumferential roller surface of the solid cutter roller.

### DETAILED DESCRIPTION

A foil cutter in accordance with embodiments of the invention are described in the following description of the figures. For reasons of simplicity, elements that coincide in their function are provided in the individual figures with the same reference numerals. In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

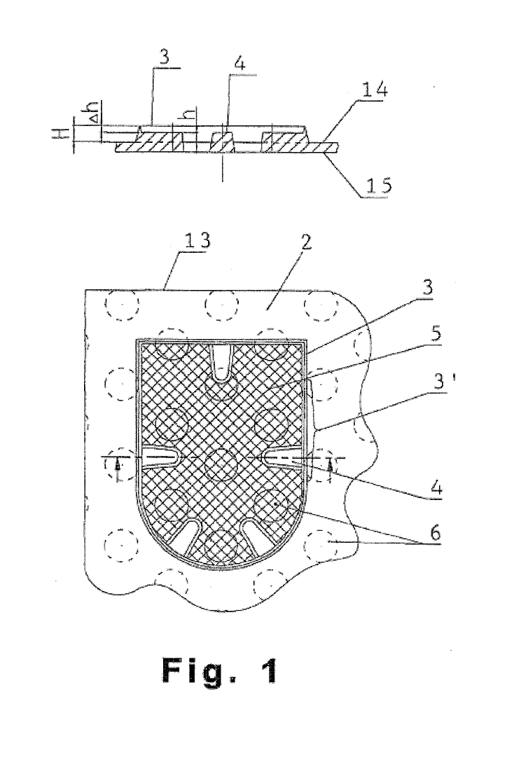

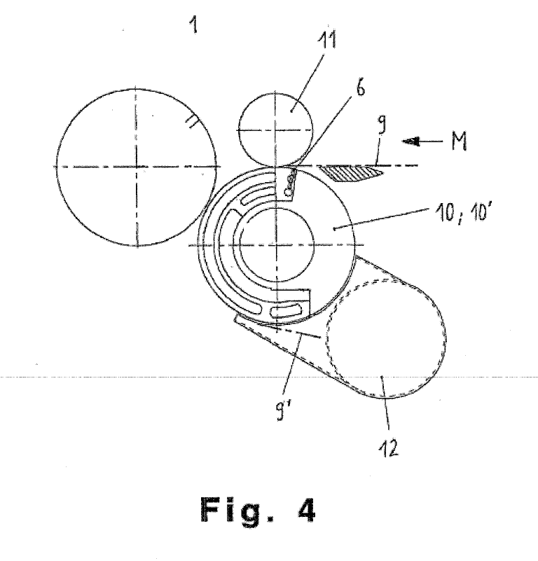

FIG. 1 shows together with FIG. 4 a rotary punch 1 with a foil cutter 2 in accordance with a first embodiment of the invention. The foil cutter 2 rests on the carrier roller but is shown unwound together with the surface of the carrier roller. The associated sectional view only shows the foil cutter 2. In this example the carrier roller is a tensioning roller with suction- and blowing air function. It forms, together with the fixed foil cutter 2, the cutter roller 10. With the aid of this cutter roller windows are punched out of the flat material 9 in accordance with the cutting contour 3 in a rotary punch process. The countercutting element 11 is a stationary countercutting strip in this instance. A connection is established by the perforation 5 between the suction- and blowing air openings 6 of the carrier roller and between the punching material 9. After the punching procedure the punched part 9*, that is a so-called window scrap in this instance, is aspirated by vacuum and transported on the circumference of the cutter roller to the transfer point of the scrap suction removal 12. There, the separation of the window scrap 9′ from the cutter roller 10 takes place by switching the suction air to blowing air. During this time the elevations 4 ensure that the punched part is not sucked entirely into the cutting form 3. A clamping of the punched part 9′ between the blades is prevented and a smooth transfer is made possible. In this embodiment the cutting height H is 0.7 mm and the height of the elevation h is 0.6 mm. The thickness of the base plate is 0.1 mm. Of course, the cited functionalities can also be achieved with dimensions differing from those above. The separating behavior can be controlled by changing the height h (applies to one or more embodiments). The elevations 4 are in direct contact, viewed from the top, with the cutting contour 3 and run from it in a web-like manner into the area of the punched part to be separated. This type of elevations is especially suitable for cutting contour sections that lie close to one another and for small, closed cutting contours (windows). The arrangement and number of elevations 4 according to one or more embodiments of the present invention is adapted to the form of the cut. A covering of a rather large area of the suction- and blowing air openings is avoided.

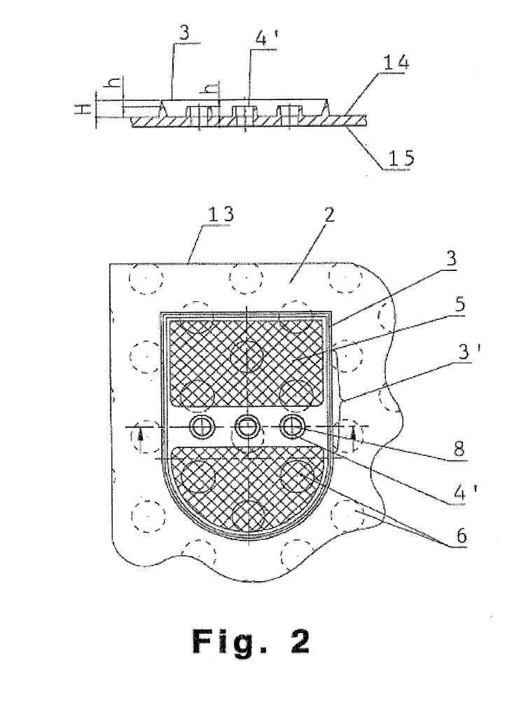

FIG. 2 shows, together with FIG. 4, a rotary punch 1 with a foil cutter 2 in accordance with a second embodiment of the invention. The difference from the first embodiment is in the shaping of the elevations 4′. They are present here in a pin design. The elevations 4′ ensure that the punched-out punched part experiences a curvature and as a consequence does not become clamped between the blades 3. A smooth transition of the punched part 9′ is made possible. The same height relationships are present as in the first embodiment. The elevations 4′ do not have a direct connection, viewed from the top, with the cutting contour 3. The perforations 8 (bores with D=1 mm) in the elevations 4′ can be used as additional suction openings for the punched parts or as blowing-off openings for the punched parts. The arrangement and number of the elevations 4′ according to one or more embodiments of the present invention is adapted to the form of the cut. This embodiment is also suitable for cutting contour sections lying close to each other and for very small, closed cutting contours.

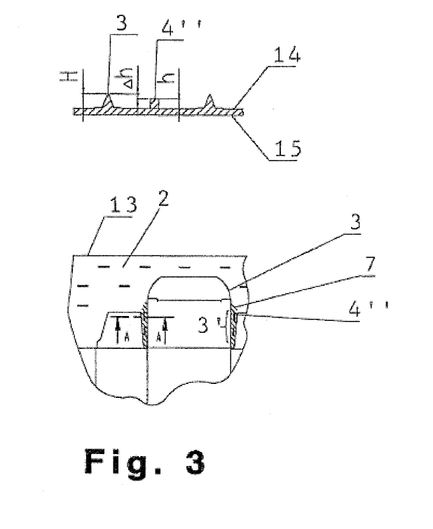

FIG. 3 shows, together with FIG. 4, a rotary punch 1 with a foil cutter 2 in accordance with a third embodiment of the invention. There are the following differences from the first two embodiments: The countercutting element 11 is a rotating cutter roller. The punched part 9′, in which the elevation 4″ in accordance with one or more embodiments of the invention is inserted, is in this case a so-called residual grid. The transfer of the punched parts 9′ to other machine apparatuses takes place in accordance with a principle that is not described in detail here. The elevations 4″ are present in a web design. The elevations 4″ ensure on the one hand that the punched card 9′ is not sucked entirely into the cutting form 3. A clamping of the punch part 9′ between the blades is prevented and a smooth transition is made possible. On the other hand, the elevations 4″ are arranged in such a manner that they guide the residual grid. In this embodiment the cutting height H is 0.6 mm and the height of the elevation h is 0.3 mm. The arrangement and number of the elevations 4″ according to one or more embodiments of the present invention is adapted to the form of the cut.

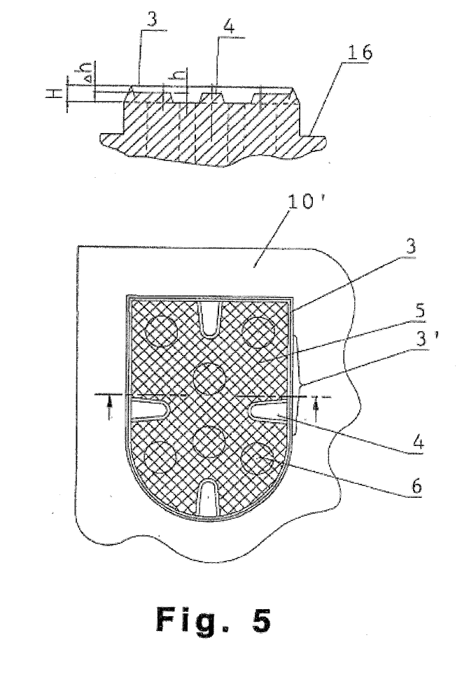

FIG. 5 shows, together with FIG. 4, an alternative embodiment of the rotary punch 1 in which, instead of a foil cutter 2, a solid cutter roller 10′ is used. The blade height of the solid cutter roller 10′ is 2.5 mm and the height of the elevations 4, 4′, 4″ is 2.4 mm. The roller t0′ is provided with a suction- and blowing air function. Further details are the same as in the variant shown in FIG. 1.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

### REFERENCE NUMERALS

1 rotary punch

2 foil cutter

3′ cutting contour

4, 4′,4″ elevation

5 foil cutter perforation (cross-hatching)

6 suction- and blowing air openings of the carrier roller

7 clamping zone (hatching)

8 perforation

9, 9′ punched material, punched part

10 cutter roller (carrier roller +foil cutter)

10′ cutter roller (solid cutter)

11 countercutting element

12 scrap funnel

13 base plate

14 top of the base plate

15 bottom of the base plate

16 circumference roller surface

D bore diameter for air passage

H blade height

h height of elevation

Δ h difference in height (Δ h=H−h)

1. A foil cutter for use on the surface area of a carrier roller of a rotary punch comprises:
a base plate with a bottom and a top; and
at least one blade arranged on the top of the base plate,
wherein the top of the base plate comprises at least one region bordering on the at least one blade and partially or completely surrounded by the at least one blade, in which at least one foil cutter perforation is present through which at least a part of punched flat material can be drawn by suction to be held in the region and be further transported by the carrier roller,
wherein the foil cutter comprises at least one elevation arranged on the top of the base plate in the at least one region bordering on the at least one blade and partially or completely surrounded by the at least one blade, and
wherein the elevation is arranged, constructed and connected to the foil cutter to prevent a clamping of the part of the punched flat material or of partial areas of the punched flat material.

2. The foil cutter according to claim 1, wherein the elevation is designed as a web, plateau, pin, blade, or as a bead.

3. The foil cutter according to claim 1, wherein the elevation comprises at least one perforation as a suction- or blowing air perforation.

4. The foil cutter according to claim 1, wherein the elevation, viewed from a top view of the foil cutter, has a direct connection with at least one cutting contour section of the at least one blade.

5. The foil cutter according to claim 1, wherein the elevation, viewed from a top view of the foil cutter, is placed between or adjacent to cutting contour sections of the one or more blades without being directly connected thereto.

6. The foil cutter according to claim 1,
wherein the height h of the elevation is less than the cutting height H or equal to the cutting height H, and
wherein the difference in height Δ h is 0% to 100% of the cutting height H.

7. The foil cutter according to claim 6,
wherein the height h of the elevation is less than the cutting height H, and
wherein the difference in height Δ h is 10% to 40% of the cutting height H.

8. The foil cutter according to claim 1, wherein the surface of the region completely surrounded by the at least one blade is less than or equal to 150 mm².

9. A solid cutter roller for a rotary punch, comprising:
at least one blade arranged on a circumferential roller surface
wherein the circumferential roller surface has at least one region bordering on blades and partially or completely surrounded by the blades, in which region suction openings for drawing in at least a part of the punched flat material are located to be drawn in to be held in the region and be further transported by the solid cutter roller,
wherein the solid cutter roller comprises at least one elevation arranged on the circumferential roller surface in the at least one region bordering on the blades and partially or completely surrounded by the blades, and
wherein the elevation is arranged, constructed and connected to the cutter roller to prevent a clamping of the part of the punched flat material or of partial areas of the punched flat material.

10. The solid cutter roller according to claim 9, wherein the cutter roller is a roller with a suction- and blowing function.

11. The solid cutter roller according to claim 9, wherein the elevation is designed as a web, plateau, pin, blade or as a bead.

12. The solid cutter roller according to claim 9, wherein the elevation comprises at least one perforation as a suction- or blowing air perforation.

13. The solid cutter roller according to claim 9, wherein the elevation, viewed from a top view of the roller surface shown unwound and of the elements arranged thereon, has a direct connection with at least one cutting contour section of the blades.

14. The solid cutter roller according to claim 9, wherein the elevation, viewed from a top view of the roller surface shown unwound and of the elements arranged thereon, is placed between or adjacent to cutting contour sections of one or more of the blades without being directly connected thereto.

15. The solid cutter roller according to claim 9, wherein the height h of the elevation is 30% to 100% of the cutting height H.

16. The solid cutter roller according to claim 15, wherein the height h of the elevation is 60% to 90% of the cutting height H.

17. The solid cutter roller according to claim 9, wherein the cutting height H is maximally 3 mm.

18. The solid cutter roller according to claim 9, wherein the surface of the region completely surrounded by the blades is less than or equal to 150 mm².
